(19) United States
(12) Patent Application Publication
(10) Pub. No.: US 2025/0268266 A1
(43) Pub. Date: Aug. 28, 2025

(54) VIBRATING FOOD CONTACT SURFACE THAT HELPS REDUCE FRICTION

(71) Applicant: Michael Nagy, Dublin, OH (US)

(72) Inventor: Michael Nagy, Dublin, OH (US)

(21) Appl. No.: 19/061,165

(22) Filed: Feb. 24, 2025

Related U.S. Application Data
(60) Provisional application No. 63/557,919, filed on Feb. 26, 2024.

(51) Int. Cl. A21B 3/00

(52) U.S. Cl. CPC A21B 3/003

(57) ABSTRACT

A cooking utensil for reducing the friction between a food contact surface and any food positioned thereon through vibrations to allow the food to more easily be transferred therefrom. The cooking utensil has a food contact member and a handle coupled to the food contact member. An actuator is coupled to the food contact member. A power supply is selectively electrically coupled to the actuator through a switch. When the switch is in a first position, the switch electrically decouples the power supply from the actuator. When the switch is in a second position, the switch electrically couples the power supply to the actuator to activate the actuator and jostling or vibrating the food contact member to reduce the higher static friction to the lower kinetic friction between the food contact member and the food.

### CROSS-REFERENCE TO RELATED APPLICATIONS

The present application claims priority to U.S. Provisional Patent Application No. 63/557,919, filed Feb. 26, 2024, the contents of which are hereby incorporated by reference in their entirety.

### TECHNICAL FIELD

The present disclosure generally relates to cooking utensils, and more particularly but not exclusively relates to vibrating cooking utensils.

### BACKGROUND

It can be difficult to transfer food from certain cooking utensils without deforming or destroying the food. The food may often stick to the cooking utensil if it's too heavy, wet, or has been sitting for too long. For these reasons among others, there remains a need for further improvements in this technological field.

### SUMMARY

One embodiment is a cooking utensil that has a food contact member, a handle coupled to the food contact member, an actuator coupled to the food contact member and configured to provide a vibrational input to the food contact member, and a power supply selectively electrically coupled to the actuator through a switch. The switch electrically couples the power supply to the actuator the vibrational input provided by the actuator is sufficient to dislodge any food positioned thereon.

In one example of this embodiment, the food contact member is made of metal. In another example, the food contact member is a pizza peel. In one example, the actuator is welded to the food contact member. In a different example, the actuator is coupled to the food contact member with at least one heat resistant epoxy or screws. Part of this example has a cover positioned over the actuator such that the actuator is positioned between the cover and the food contact member.

In yet another example of this embodiment, the actuator is a vibration motor. In yet another example, the power supply comprises one or more batteries. In part of this example, the one or more batteries are interchangeable. In a different example, the power supply is rechargeable. In yet another example, the switch is coupled to the handle. In another example, the power supply is positioned within a cavity formed by the handle. In another example, the handle is adjustable.

Another embodiment of this disclosure is a method of manufacturing a cooking utensil. This method includes coupling a handle to a food contact member, coupling an actuator to one or more of the food contact member or the handle, and electronically coupling a power supply to the actuator through a switch to selectively power the actuator. In this embodiment, when the actuator is powered the actuator provides a vibrational input to the food contact member to dislodge any food positioned thereon.

One example of this embodiment includes positioning the power supply in a cavity defined by the handle. In another example of this embodiment, the food contact member is a pizza peel.

Another embodiment of this disclosure is a method of operating a cooking utensil that includes positioning a switch in an engaged position, jostling or vibrating a food contact member with an actuator while the switch is in the engaged position to dislodge any food positioned on the food contact member, and transferring food from the food contact member.

One example of this embodiment includes transitioning the switch to a disengaged position once any food on the food contact member is removed. Another example includes increasing a voltage of the power supply. Yet another example of this embodiment includes adjusting a frequency of vibration provided by the actuator.

Further embodiments, forms, features, and aspects of the present application shall become apparent from the description and figures provided herewith.

### BRIEF DESCRIPTION OF THE FIGURES

FIG. 1 is top view of one embodiment of this disclosure;

FIG. 2a is a bottom view of the embodiment of FIG. 1;

FIG. 2b is a bottom view of the embodiment of FIG. 2a with a cover illustrated thereon;

FIG. 3 is a logic flowchart for one embodiment of this disclosure; and

FIG. 4 is a logic flowchart for one embodiment of this disclosure.

Corresponding reference numerals are used to indicate corresponding parts throughout the several views.

### DETAILED DESCRIPTION OF ILLUSTRATIVE EMBODIMENTS

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should further be appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Items listed in the form of “A, B, and/or C” can also mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

In the drawings, some structural or method features may be shown in certain specific arrangements and/or orderings. However, it should be appreciated that such specific arrangements and/or orderings may not necessarily be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may be omitted or may be combined with other features.

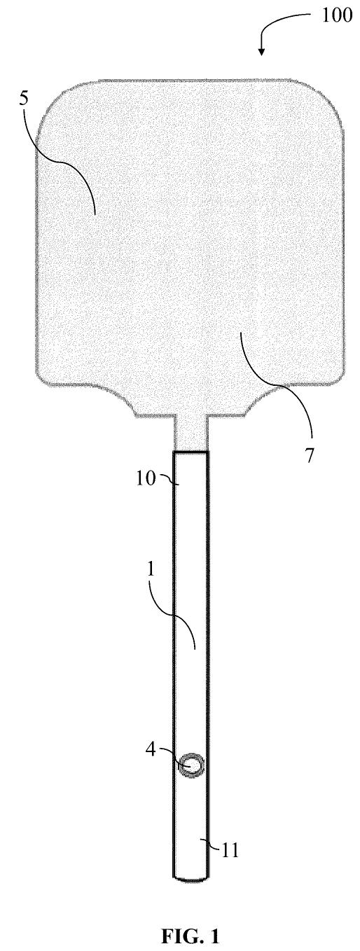

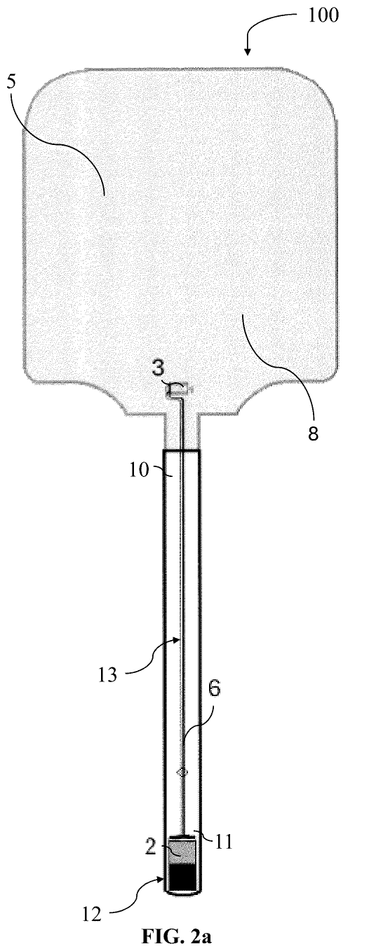

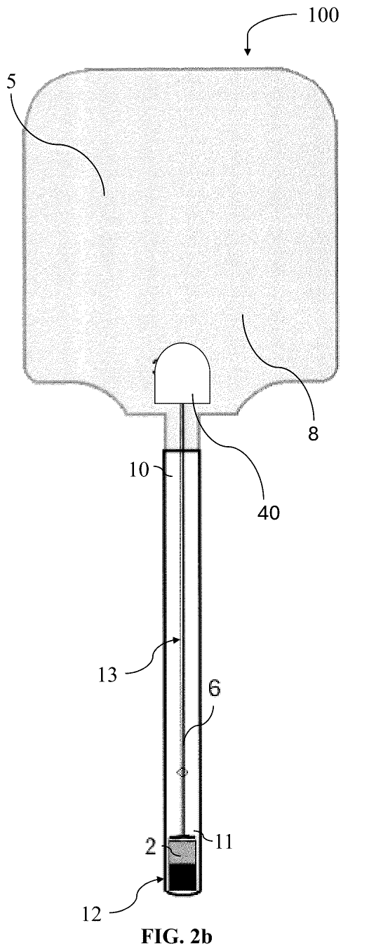

With reference to FIGS. 1 and 2, one embodiment of a cooking utensil 100 is shown. The cooking utensil 100 includes a handle 1, a power source 2, an actuator 3, a switch 4, and a food contact member 5. The handle 1 may be coupled to the food contact member 5.

The food contact member 5 may have a first surface 7 and a second surface 8, wherein the second surface 8 is positioned on the food contact member 5 opposite the first surface 7. In certain forms, food may be positioned on the first surface 7 of the food contact member 5. In other forms, food may be positioned on the second surface 8 of the food contact member 5.

As shown in FIG. 1, the food contact member 5 may be a pizza peel. However, this disclosure also contemplates that the food contact member 5 may be in other forms, for example a spatula, a pie server, or any other kitchen utensils or items configured to transfer food.

In some embodiments, the food contact member 5 may be made of metal, for example, aluminum among other metals and metal alloys. The food contact member 5 being made of metal allows for use of the cooking utensil 100 in hotter conditions, for example in a fire oven or a stove. However, the food contact member 5 may be made of any other material, for example wood, plastic, and other known materials used for food utensils.

In certain forms, the handle 1 may be made of wood. The handle 1 may have a first end 10 and second end 11. The first end 10 may be coupled to the food contact member 5. A compartment or cavity 12 may be formed in the handle 1. In some embodiments, the compartment 12 may be positioned at the second end 11 of the handle 1. In other embodiments, the compartment 12 may be positioned elsewhere on the handle 1. The compartment 12 may be sized to accommodate the power supply 2. The length of the handle 1 may vary without changing the fundamental utility of the cooking utensil 100. In certain forms, the handle 1 may be adjustable.

The actuator 3 may be coupled to the food contact member 5 or otherwise proximate thereto. In certain embodiments, the actuator 3 may be coupled to the second surface 8 of the food contact member 5. However, it should be understood that the actuator 3 may be coupled to the food contact member 5 at a different location. Alternatively, the actuator 3 may be coupled to the handle 1 at a location that allows the actuator 3 apply the necessary input to the food contact member 5 discussed herein.

The actuator 3 may be activated, therefore jostling or vibrating the food contact member 5. More specifically, the actuator 3 is configured to jostle or vibrate the surface of which the food is positioned on, for example the first surface 7. The actuator 3 may be permanently attached to the food contact member 5 or removable coupled thereto. Regardless, the actuator 3 is securely fixed to the food contact member 5 or handle 1 to efficiently jostle or vibrate the food contact member 5 when activated and remain coupled to the food contact member 5 or handle 1. In certain forms, the actuator 3 may be welded to the food contact member 5. However, the actuator 3 may be coupled to the food contact member 5 or handle 1 in other ways, for example heat resistant metal epoxy, heat resistant concrete epoxy, or screws, to name a few. The actuator 3 may also be deactivated, therefore stopping the actuator 3 from jostling or vibrating the food contact member 5. The frequency of vibration provided by the actuator 3 may be adjusted to improve the function of the cooking utensil 100.

In some embodiments, the actuator 3 may be a vibration motor, for example a direct current (DC) vibration motor. Some examples of vibration motors are unbalanced motors, electromagnetic motors, eccentric rotating mass motors, and linear resonant actuators to name a few. In other embodiments, the actuator 3 comprises any known device capable of providing the described vibrational inputs to the food contact member 5.

The power supply 2 may be selectively electrically coupled to the actuator 3 through the switch 4 and one or more wires 6. More specifically, the power supply 2 may be connected to the switch 4 using one or more wires 6. The switch 4 may be connected to the actuator 3 using one or more wires 6 and the actuator 3 may then be connected to the power supply 2 through one or more wires 6 to complete a circuit. The switch 4 is configured to activate and deactivate the actuator 3. In certain forms, the switch 4 is configured to selectively control the activation of the actuator 3. The switch 4 may contain one or more positions to control the activation of the actuator 3. For example, the switch 4 may be in a first position in which power is not supplied to the actuator 3. The switch 4 may contain a second position in which power is provided to the actuator 3.

As shown in FIG. 1, the switch 4 may be coupled to the handle 1. However it should be understood that the switch 4 may be positioned elsewhere on the cooking utensil 100 without changing the function of the cooking utensil 100. While the embodiment in FIG. 1 shows the switch 4 as a push button switch, this should be non-limiting. In certain forms, the switch 4 may be another type switch, for example a toggle switch, a slide switch, or a receiver for a wireless switch to name a few. Further, the switch 4 may be located at a position that a user would typically grasp the handle 1 in use. In this configuration, the user can easily manipulate the switch 4 while utilizing the food contact member 5 to manipulate food-allowing the user to easily engage and disengage the actuator 3 while manipulating the food.

In some embodiments, a channel 13 may be formed in the handle 1. The channel 13 may extend from the first end 10 of the handle 1 to the compartment 12. The channel 13 may be configured to receive the one or more wires 6 to allow for connections to the power supply 2, the actuator 3, and the switch 4. However, it should be understood that the one or more wires 6 may be positioned elsewhere on or within the cooking utensil 100 without changing the function of the cooking utensil 100. In certain forms, the one or more wires 6 may be insulated.

The power source 2 is configured to provide power to the actuator 3. In certain forms, the power supply 2 may be one or more batteries. In some embodiments, the power source may be a 6 volt battery or equivalent, such as four AA-sized batteries. In other embodiments, the power supply 2 may be a 9 volt battery or equivalent. In some embodiments, the power supply 2 may be any other power source configured to provide power to the actuator 3. The power source 2 may be replaceable, for example interchanging the power source 2. In certain forms, the power source 2 may be rechargeable, for example a rechargeable battery. Having the power source 2 be a rechargeable battery allows for the power source 2 to be permanently installed to the cooking utensil 100 and may be plugged in for charging. Increasing the voltage of the power supply 2 may further improve the function of the cooking utensil 100.

In some embodiments, the power source 2 may be positioned within the compartment 12. However, the power source 2 may be positioned elsewhere on the cooking utensil 100 without changing the function of the cooking utensil 100.

In certain forms, the actuator 3 may be protected by a housing or cover 40. The cover 40 may be positioned around the actuator 3 and coupled to the food contact member 5 such that the actuator 3 is positioned therebetween. The cover 40 provides protection to the actuator 3 from becoming disconnected from the one or more wires 6 among other things. Further, the cover 40 provides protection to the actuator 3 from food and/or from when the cooking utensil 100 is being cleaned. Additionally, the cover 40 may contain insulation to protect the actuator 3 from heat while using the cooking utensil 100. Further still, the cover 40 may ensure the actuator 3 effectively transfers vibrational inputs to the food contact member 5 by providing additional support coupling the actuator 3 to the food contact member 5.

When food is positioned on the food contact member 5, the food may have a static force between the food and the food contact member 5. The equation to determine the static friction between the food and the food contact member 5 may be defined by the equation Fₛ=μₛN, where Fₛ is the force of static friction between the food and the food contact member, μₛ is the coefficient of static friction between the food and the food contact member, and N is equal to the normal force of the food on the food contact member 5. The food may stay positioned on the food contact member 5 by the static friction such that to slide the food off the food contact member 5, a force applied to the food must exceed the force of static friction between the food and the food contact member.

Once the force applied to the food exceeds the force of static friction, kinetic friction may act between the food and the food contact member 5. The equation to determine the kinetic friction between the food and the food contact member 5 may be defined by the equation Fₖ=μₖN, where Fₖ is the force of kinetic friction between the food and the food contact member, μₖ is the coefficient of kinetic friction between the food and the food contact member, and N is equal to the normal force of the food on the food contact member 5.

The coefficient of static friction μₛ is usually higher than the coefficient of kinetic friction μₖ. As a result, when the food has the same normal force N on the food contact member 5, the force of static friction Fₛ is greater than the force of kinetic friction Fₖ.

Flour may be used to reduce the static friction between the food contact member 5 and the food. However, the use of too much flour may affect the taste of the food. Advantages of the cooking utensil 100 will become apparent as described below as well as reducing the amount of flour needed to transfer the food from the cooking utensil.

When the switch 4 is in the first position in which power is not provided from the power source 2 to the actuator 3, the food contact member 5 may not jostle or vibrate via the actuator 3.

When the switch 4 is in the second position, power may be provided from the power source 2 to the actuator 3, thus activating the actuator 3. Activating the actuator 3 jostles and/or vibrates the food contact member 5 relative to the food such that the food transitions from requiring the higher static friction force to move from the food contact member 5 to only requiring the lower kinetic friction force to move from the food contact member 5. In short, jostling and/or vibrating the food contact member 5 relative to the food allows for less force needed to be applied to transfer the food off the cooking utensil 100 because the coefficient of friction is altered from the coefficient of static friction to the lower coefficient of kinetic friction when the actuator 3 is engaged. Reducing the force needed to be applied to transfer the food off the cooking utensil 100 may help a user to transfer the food without ruining the food if it gets stuck to the cooking utensil 100. Additionally, less flour may be needed between the food and the food contact member 5, preserving the food quality of any food positioned on the food contact member.

The actuator 3 may continue to be activated to keep the food contact member 5 vibrating or moving relative to the food, ultimately keeping the food at least partially moving relative to the food contact member 5. The actuator 3 continuing to be activated reduces the force needed to transfer the food off of the cooking utensil 100 as described above. Keeping the actuator 3 activated allows a user of the cooking utensil 100 to easily transfer food off the cooking utensil 100 while the food is at least partially moving relative to the food contact member 5. Increasing the time the food is at least partially moving relative to the food contact member 5 reduces the speed, skill, and consistency needed to transfer the food from the cooking utensil. Therefore, increasing the time the food is at least partially moving relative to the food contact member 5 reduces the need for precise timing from a user to apply a force to transfer the food from the cooking utensil 100 while the food is at least partially moving relative to the food contact member 5, ultimately reducing the likelihood of the user deforming or ruining the food.

The switch may be positioned in the first position deactivating the actuator 3. In certain forms, the switch 4 may be positioned in the first position when the food has been transferred off of the food contact member 5. Similarly, the user may position the switch 4 in the first position when the user is finished using the cooking utensil 100. It should be understood that the switch 4 may contain any number of positions.

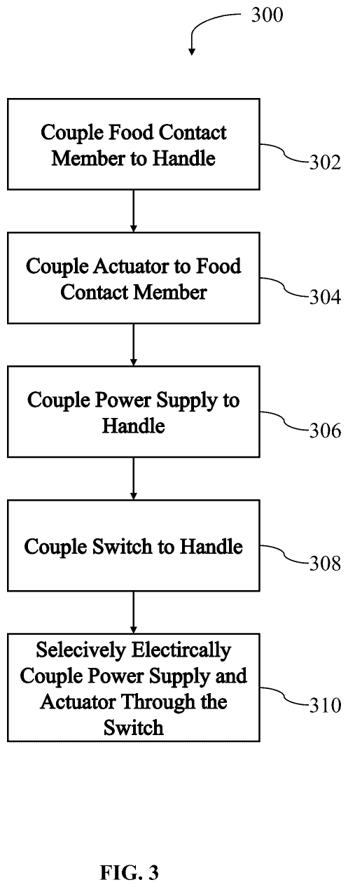

With additional reference to FIG. 3, an exemplary process 300 that may be performed to manufacture the cooking utensil 100 is illustrated. Blocks illustrated for the processes in the present application are understood to be examples only, and blocks may be combined or divided, and added or removed, as well as re-ordered in whole or in part, unless explicitly stated to the contrary. Additionally, while the blocks are illustrated in a relatively serial fashion, it is to be understood that two or more of the blocks may be performed concurrently or in parallel with one another. Moreover, while the process 300 is described herein with specific reference to the cooking utensil 100 illustrated in FIGS. 1 and 2, it is to be appreciated that the process 300 may be performed with the cooking utensil 100 having additional and/or alternative features.

Block 302 may include coupling a food contact member 5 to a handle 1. In certain forms, coupling the food contact member 5 to a handle 1 may include coupling a metal food contact member to the handle. In certain forms, the food contact member 5 may be a pizza peel. The handle may be coupled to the food contact member utilizing any known coupling method. For example, adhesives or mechanical fasteners may be used to contact the handle to the food contact member.

Block 304 may include coupling an actuator 3 to the food contact member 5. In some embodiments, the actuator 3 may be a vibration motor. In certain embodiments, the actuator 3 may be a DC vibration motor. In certain forms, coupling the actuator 3 to the food contact member 5 may include coupling the actuator 3 to a second surface 8 of the food contact member 5. As discussed herein, in one aspect of this disclosure a cover may be coupled over the actuator 3 as part of this coupling process. For example, adhesive or the like may be applied around and on the actuator 3. Additionally adhesive may be applied on and around the actuators 3 after positioned on the food contact member 5 and the cover 40 may be positioned thereover. This allows the cover 40 to protect the actuator 3 from heat and other potentially damaging environmental inputs that may be expected in use.

Block 306 may include coupling a power supply 2 to the handle 1. In certain forms, coupling the power supply 2 to the handle 1 may include coupling a rechargeable power supply to the handle 1, for example a rechargeable battery. In certain forms, block 306 may include positioning the power supply 2 in a compartment or cavity 12 defined by the handle 1. In certain forms, the compartment or cavity 12 may be defined in the back of the handle 1.

Block 308 may include coupling a switch 4 to the handle 1. Block 308 may further include positioning one or more wires 6 within a channel 13 defined by the handle 1. As noted herein, the switch may be coupled to handle at a location that would be typically gripped by a user in use, such that the switch 4 can easily be manipulated by a user during use.

Block 310 may include selectively electrically coupling the power supply 2 and the actuator 3 through the switch 4. The switch 4 may be positioned in a first position in which the power supply 2 is electrically decoupled from the actuator 3 through the switch 4. The switch 4 may be positioned in a second position in which the power supply 2 is electrically coupled to the actuator 3 through the switch 4 to jostle or vibrate the food contact member 5.

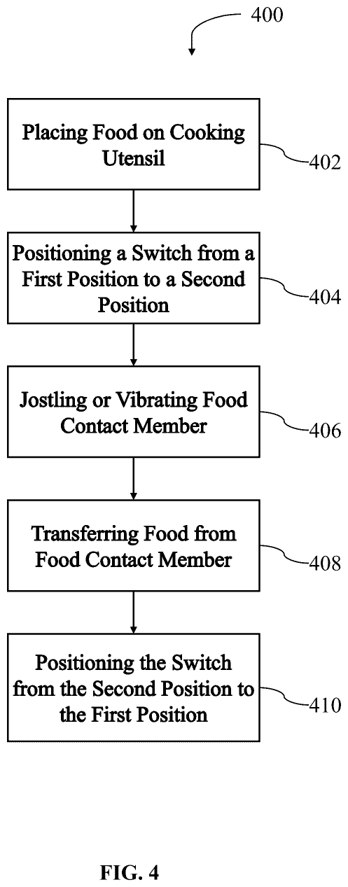

With additional reference to FIG. 4, an exemplary process 400 that may be performed using the cooking utensil 100 is illustrated. Blocks illustrated for the processes in the present application are understood to be examples only, and blocks may be combined or divided, and added or removed, as well as re-ordered in whole or in part, unless explicitly stated to the contrary. Additionally, while the blocks are illustrated in a relatively serial fashion, it is to be understood that two or more of the blocks may be performed concurrently or in parallel with one another. Moreover, while the process 400 is described herein with specific reference to the cooking utensil 100 illustrated in FIGS. 1 and 2, it is to be appreciated that the process 400 may be performed with the cooking utensil 100 having additional and/or alternative features.

Block 402 may include placing food on a cooking utensil 100. In certain forms, placing food on the cooking utensil 100 may include placing food on a food contact member 5 of the cooking utensil 100. In certain forms, placing food on the cooking utensil 100 may further include placing food on a first surface 7 of the food contact member 5 of the cooking utensil 100. As one example, the food contact member 5 may be sized to accommodate a pizza and the food considered herein is a created pizza.

Block 404 may include positioning a switch 4 of the cooking utensil from a first position to a second position, wherein the switch 4 in the first position electrically decouples a power supply 2 and an actuator 3, wherein the switch 4 in the second position electronically couples the power supply 2 and the actuator 3. Positioning the switch 4 from the first position to the second position may selectively provide power from the power supply 2 to the actuator 3 through the switch 4. In certain forms, block 404 may further comprise increasing the voltage of the power supply 2.

Block 406 may include jostling or vibrating a food contact member 5 via the actuator 3. The actuator 3 may be coupled to the food contact member 5 such that providing power from the power supply 2 to the actuator 3 activates the actuator 3 and accordingly jostles or vibrates the food contact member 5. Jostling or vibrating the food contact member 5 may reduce the higher coefficient of static friction to a lower coefficient of kinetic friction between the food contact member 5 and food positioned on the food contact member 5 as described above. In certain forms, block 406 may further comprise adjusting the frequency of vibration provided by the actuator 3.

Block 408 may include transferring food from the food contact member 5. In one aspect of this disclosure, blocks 406 and 408 may be executed at substantially the same time. Regardless, transferring food from the food contact member 5 may include transferring food off of the food contact member 5, for example sliding food off of the food contact member 5. Transferring food from the food contact member 5 may include transferring food from the food contact member 5 into an oven. In certain embodiments, transferring food from the food contact member 5 may include transferring pizza from the food contact member 5 into an oven.

Block 410 may include positioning the switch 4 from the second position to the first position. Positioning the switch 4 in the first position may electronically decouple the power supply 2 and the actuator 3 through the switch 4 such that power is not provided from the power supply 2 to the actuator 3. The switch in the first position may deactivate the actuator 3 such that the actuator 3 is not jostling or vibrating the food contact member 5. The switch 4 may be positioned in the first position when the cooking utensil 100 is done being used, for example after food has been transferred from the food contact member 5.

In certain forms when the food contact member 5 is a pizza peel, the cooking utensil may be used in the same way as a standard restaurant-style pizza peel except that when the uncooked pizza is ready to slide into the oven, the user can activate the switch 4 to start the vibration allowing the pizza to slide more easily off the food contact member 5 and into the oven without substantially visibly changing the look of the cooking utensil or its use. However, other forms of a food contact member 5 are considered herein, and the food contact member may take different forms such as a spatula, pie server, or other kitchen items with a similar use case. Additionally, this disclosure also contemplates embodiments wherein the cooking utensil may be used when transferring other types of food beyond pizza (breads, etc.) as well.

While the disclosure has been illustrated and described in detail in the drawings and foregoing description, the same is to be considered as illustrative and not restrictive in character, it being understood that only the preferred embodiments have been shown and described and that all changes and modifications that come within the spirit of the disclosure are desired to be protected.

It should be understood that while the use of words such as preferable, preferably, preferred or more preferred utilized in the description above indicate that the feature so described may be more desirable, it nonetheless may not be necessary and embodiments lacking the same may be contemplated as within the scope of this disclosure, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least partially moving” is used, some of the item may be moving and/or the entire item may be moving unless specifically stated to the contrary.

What is claimed is:

1. A cooking utensil comprising:
a food contact member;
a handle coupled to the food contact member;
an actuator coupled to the food contact member or the handle and configured to provide a vibrational input to the food contact member; and
a power supply selectively electrically coupled to the actuator through a switch;
wherein when the switch electrically couples the power supply to the actuator the vibrational input provided by the actuator is sufficient to dislodge any food positioned thereon.

2. The cooking utensil of claim 1, wherein the food contact member is made of metal.

3. The cooking utensil of claim 1, wherein the food contact member is a pizza peel.

4. The cooking utensil of claim 1, wherein the actuator is welded to the food contact member.

5. The cooking utensil of claim 1, wherein the actuator is coupled to the food contact member with at least one heat resistant epoxy or screws.

6. The cooking utensil of claim 1, wherein the actuator is a vibration motor.

7. The cooking utensil of claim 5, further comprising a cover positioned over the actuator such that the actuator is positioned between the cover and the food contact member.

8. The cooking utensil of claim 1, wherein the power supply comprises one or more batteries.

9. The cooking utensil of claim 8, wherein the one or more batteries are interchangeable.

10. The cooking utensil of claim 1, wherein the power supply is rechargeable.

11. The cooking utensil of claim 1, wherein the switch is coupled to the handle.

12. The cooking utensil of claim 1, wherein the power supply is positioned within a cavity formed by the handle.

13. The cooking utensil of claim 1, wherein the handle is adjustable.

14. A method of manufacturing a cooking utensil, the method comprising:
coupling a handle to a food contact member;
coupling an actuator to one or more of the food contact member or the handle; and
electronically coupling a power supply to the actuator through a switch to selectively power the actuator;
wherein when the actuator is powered the actuator provides a vibrational input to the food contact member to dislodge any food positioned thereon.

15. The method of claim 14, positioning the power supply in a cavity defined by the handle.

16. The method of claim 14, wherein the food contact member is a pizza peel.

17. A method of operating a cooking utensil, the method comprising:
positioning a switch in an engaged position,
jostling or vibrating a food contact member with an actuator while the switch is in the engaged position to dislodge any food positioned on the food contact member; and
transferring food from the food contact member.

18. The method of claim 17 further comprising transitioning the switch to a disengaged position once any food on the food contact member is removed.

19. The method of claim 17 further comprising increasing a voltage of the power supply.

20. The method of claim 17 further comprising adjusting a frequency of vibration provided by the actuator.
